(19) United States
(12) Patent Application Publication
(10) Pub. No.: US 2026/0044150 A1
(43) Pub. Date: Feb. 12, 2026

(54) POINT OF INTEREST FACILITY MARKING MODULES AND SYSTEMS AND METHODS OF USING TIIE SAME

(71) Applicant: FREDERICK MOBILE INSTRUMENTATION, LLC, Huntsville, AL (US)

(72) Inventors: Andrew Frederick NICHOLS, Huntsville, AL (US); Connie ALLEN, Huntsville, AL (US); Dwight MEDLEY, Huntsville, AL (US)

(73) Assignee: FREDERICK MOBILE INSTRUMENTATION, LLC, Huntsville, AL (US)

(21) Appl. No.: 19/100,283

(22) PCT Filed: Aug. 3, 2023
(86) PCT No.: PCT/US2023/071612

§ 371 Date: Jan. 31, 2025

Related U.S. Application Data
(60) Provisional application No. 63/370,419, filed on Aug. 4, 2022.

(51) Int. Cl. G05D 1/247; B66F 9/06; B66F 9/075; G05D 1/617; G05D 105/28; G05D 107/70; G05D 109/10; G05D 111/30

(52) U.S. Cl. CPC G05D 1/247; B66F 9/063; B66F 9/0755; G05D 1/617; G05D 2105/28; G05D 2107/70; G05D 2109/10; G05D 2111/34

(57) ABSTRACT

Facility marking modules (FMM) and methods and systems of using the same. A FMM is associated with a point of interest (POI) at a worksite or other facility. The FMM detects a low frequency magnetic field of a vehicle moving within the facility at or near the POI and transmits a response signal to a proximity detection system (PDS) of the vehicle. The response signal can cause an operational alert lo activate, or to slow, stop, or change direction of the vehicle based on traffic restrictions associated with the POI. In some examples, the response signal can be used to generate vehicular traffic data for improving efficiency and/or safety of the facility.

This application is being filed on Aug. 3, 2023, as a PCT International Patent application and claims the benefit of and priority to U.S. Provisional patent application Ser. No. 63/370,419, filed Aug. 4, 2022, the entire disclosure of which is incorporated by reference herein in its entirety

### FIELD OF THE DISCLOSURE

This disclosure relates to vehicular and pedestrian safety, traffic control, and tracking at worksites.

### BACKGROUND

A variety of concepts have been conceived and tried that provide continuous tracking of moving vehicles and personnel throughout a facility in order to avoid workplace accidents, e.g., collisions with machinery, vehicles, and workers. Many of these safety and tracking systems are centralized and attempt to accomplish all of the interpretations of movements and calculations required to provide a safe working environment and track all of the physical and spatial information. There are many practical problems with these centralized approaches that limit their effectiveness. For example, the centralized approaches require placing the geometry of the facility into a centralized computer system and this geometry must be kept current, a job that is not always easy with frequent shifting locations of products and even parts of the facilities being moved from time to time. And, every item of interest, every vehicle, every person, every object that is relocated must be known and fed into the centralized system. An even more burdensome task is the making of judgements in advance about how to accurately interpret the changes in physical relationships of all these items, while trying to be certain that & safety related consideration is not overlooked or misunderstood. In addition, if there is a failure of the centralized safety and tracking system, then there is a total failure at the work site and all work must stop until the issues are addressed.

Many creative ideas have been studied for workplace safety and tracking and some have been successfully implemented. However, experience has shown that each developed idea tends to be effective to solve some specific problems or do specific jobs but tend to be ineffective or impractical to implement for solving other problems or doing other jobs. Attempts to combine many differing ideas into a composite system tend to be burdensome since each new development tends to require its own resources and support. For example, radio frequency identification systems, such as radio frequency identification (RFID) have been used to provide location awareness of hazardous environments. However, RFID technology cannot precisely be used to Identify safety boundaries within an industrial or commercial environment because the RFID waves are too easily reflected by an environment typically filled with industrial equipment, for example, racks, trucks, loading equipment, and inventory, leading to multiple propagation paths and errors. As such, RFID is not sufficient accurate for precise tracking and for providing safety information.

U.S. Pat. No. 5,939,986 disclosed the use of closed-loop, low frequency, magnetic fields to allow mining machines in underground mines to detect pedestrians and to warn both the pedestrians and the operators when they are in close proximity. Since then, many new, novel ideas have been disclosed that expanded and improved upon this idea for use in most types of industrial environments, and these ideas have been successfully implemented in new ways, that avert accidents and provide useful data about the equipment operations. These advances are described in detail in numerous Frederick patents, that are referenced in this disclosure.

Although, systems and techniques have been revealed in the various referenced Frederick patents, and have been successfully implemented, that allow vehicles to also detect and interact to avert collisions with facility elements and to keep vehicles from entering unsafe locations, there remains a need for simpler, low cost, devices that expand these capabilities and enhance the value of the detection systems on vehicles, such as fork trucks, and many other types of vehicles

### SUMMARY In general terms, the present disclosure is directed to a point of interest vehicular control system.

As used herein, a point of interest (POI) is any structure or location within a worksite (e.g., a warehouse or other facility) at or around which there is an interest in tracking and/or controlling vehicular movements to improve safety of the facility, e.g., by minimizing the occurrence and/or severity of collisions at or near the POI, and/or to improve efficiency of the facility, e.g., by reducing vehicular congestion at the POI.

A POI vehicular control system according to the present disclosure can include one or more facility marking modules (FMM). Each FMM can be fixed in place within the facility at or near a POI. In some examples, each POI of the facility is associated with its own FMM. For instance, a FMM can be fixed to a fixed structure of the facility that corresponds to a POI of the facility

Each FMM of the POI vehicular control system is configured to detect and process low frequency magnetic fields transmitted by a proximity detection system (PDS) of a vehicle positioned in the facility.

According to some examples, upon detection of such a magnetic field, the FMM is configured to generate and transmit an appropriate response signal to the PDS and/or to another system of the vehicle. The response signal can include information about the POI that the PDS or other vehicle system can process to determine its next move with respect to the POI. In some examples, the response signal can cause an alarm of the vehicle to activate or an alert to be generated that alerts the operator of the vehicle In some examples, the response signal can cause the vehicle to stop, slow down or change direction.

According to some examples, the FMM is configured to determine, based on the signal received from the PDS, information about the vehicle, such as the vehicle's size, speed, operator, ID, timestamp, and so forth. A response signal generated by the FMM can depend on the information it receives about the vehicle.

According to some examples, upon detection of such a magnetic field, the FMM is configured to generate and send data to a computing system external to the FMM The data can include information about the vehicle, such as the vehicle type, the vehicle operator, the vehicle size, the vehicle's speed, the vehicle's direction of motion, the time the vehicle was detected, and so forth. Data collected over time using FMMs of the facility can be analyzed by the computing system to determine one or more vehicular traffic conditions or traffic inefficiencies at the facility. In some examples, the computing system can generate traffic rules to improve vehicular traffic efficiency within the facility.

Thus, FMMs of the present disclosure can provide benefits of being able to maintain safety and avoid collisions in complex work environments while also being able to track and collect information about the movement of machinery.

According to aspects of the present disclosure, devices and methods of usage are provided that allow greater detection capabilities and tracking of vehicles at or near POIs, and for greater autonomous detection and control by the vehicle or the vehicle's operator.

According to aspects of the present disclosure, the FMMs hereby disclosed may be powered by low voltage, low current, power supplies provided by the facility or may be battery powered, using hibernation capabilities that will be described.

According to certain specific aspects, the present disclosure is directed to a point of interest (POI) vehicular control system, including: a fixed-position facility marker module (FMM) associated with a fixed structure, the FMM including: a processor, a tuned circuit configured to receive low magnetic frequency fields, the tuned circuit including a capacitor and an inductor, a UHF transceiver; and an antenna; wherein the FMM is configured to transmit signals using the processor, the UHF transceiver and the antenna only in response to receiving, by the tuned circuit, a pulse of a low magnetic frequency field.

According to further specific aspects, the present disclosure is directed to: a facility marker module (FMM), including: a housing, supporting: a processor; a tuned circuit configured to receive low magnetic frequency fields, the tuned circuit including a capacitor and an inductor; a UHF transceiver; and an antenna; wherein the FMM is configured to transmit signals using the processor, the UHF transceiver and the antenna only in response to receiving, by the tuned circuit, a pulse of a low frequency magnetic Reld; and wherein the housing is configured to be mounted to a structure associated with a point of interest of a facility.

According to further specific aspects, the present disclosure is directed to: a computer implemented method, including: generating a vehicular traffic report based on data exchanged between a proximity detection system of a moving vehicle and a facility marking module (FMM) fixed to a structure associated with a point of interest of a facility.

### BRIEF DESCRIPTION OF THE DRAWINGS

FIG. 1 is a schematic representation of an example facility with vehicles, points of interest, and facility marking modules of an example point of interest vehicular control system in accordance with the present disclosure.

FIG. 2 is a schematic representation of an example distribution center with very narrow aisles and cold storage, and with vehicles, points of interest, and facility marking modules of a further example of a point of interest vehicular control system in accordance with the present disclosure.

FIG. 3 is a schematic representation of an embodiment of a facility marker module according to the present disclosure.

FIG. 4 is a schematic representation of a further embodiment of a facility marker module according to the present disclosure.

FIG. 5 is a schematic representation of a further embodiment of a facility marker module according to the present disclosure.

FIG. 6 is a schematic representation of an example vehicle control interface, in accordance with the present disclosure.

FIG. 7 is a schematic representation of an example event monitoring system of the present disclosure, using one or more facility marker modules in accordance with the present disclosure.

### DETAILED DESCRIPTION OF THE INVENTION

Low frequency magnetic fields have been used to produce safety zones, safety markers, warnings, and automatic actions that protect personnel from being hit by mobile machines. See the Frederick patents, discussed below. This technology has been proven effective for providing Proximity Detection Systems (PDS) and Collision Avoidance Systems (CAS) (PDS/CAS) in many industrial environments. For purposes of this disclosure, a PDS system can be a CAS system in some cases. The high reliability and precision of these low frequency magnetic field systems has led to a variety of system configurations and devices that protect pedestrians, prevent collisions between vehicles and/or machines, and prevent collisions with facility items. Examples of these devices are disclosed in U.S. Pat. No. 7,420,471 (the '471 patent), U.S. Pat. No. 8,169,339 (the '335 patent), U.S. Pat. No. 8,552,882 (the '882 patent) U.S. Pat. No. 8,232,888 (the '888 patent), U.S. Pat. No. 8,446,277 (the '277 patent), U.S. Pat. No. 8,847,780 (the '780 patent), U.S. Pat. No. 8,710,979 (the '979 patent), U.S. Pat. No. 8,810,390 (the '390 patent), U.S. Pat. No. 9,081,046 (the '046 patent), U.S. Pat. No. 9,280,885 (the '885 patent), U.S. Pat. No. 9,822,927 (the '927 patent), and U.S. Pat. No. 10,591,027 (the '627 patent), International PCT application publication number WO2021/194904 (the '904 publication), and International PCT application number PCT/US2022/016226 (the '626 application) which patents, publications, and applications are herein referred to collectively as the “Frederick patents,” the disclosures of which are incorporated herein by reference in their entireties.

The Frederick patents have been used successfully on, for example, fork trucks, loaders, top picks, floor sweepers, tractors, cranes, and other types of machinery. The systems of the present disclosure can be applied to these types of vehicles and others. The Frederick patents describe the useful properties of low frequency magnetic fields that allow for precise, effective proximity detection, even when the source and the sensing device are separated by a wide range of materials and objects. Non-metallic materials essentially have little effect on these fields and even metal objects between the source and detection do not have a significant effect. Effects from multi-path propagation is also avoided. The location of magnetic field generators and detectors are not constrained in the same way that optical devices, like cameras are, which is important in typical industrial settings line of site is not always available. Line of sight is not required for disclosed basic PDS functionality, as is explained in the mentioned Frederick patents. Being able to not rely on line of sight is also beneficial to FMMs, tracking, and reporting as will be illustrated later.

As will be discussed herein, FMMs at POIs can add additional functionality to a decentralized PDS system, expanding its capability to account for movements which are typically more difficult to manage. Such FMMs can also be useful in tracking the locations of various industrial resources, for example, equipment, trucks, forklifts, and cranes.

The presently described FMMs and associated systems work with a PDS system that is fundamentally autonomous, i.e., decentralized. Because the FMMs and associated systems are compatible with, and supportive to, a decentralized architecture that already has proven powerful capabilities, the sum of this disclosure and the proven architecture not only provides valuable new capabilities, but also broadens and further equips the PDS architecture with additional decentralized capabilities.

As just one example, the '627 patent describes how low frequency fields can also be used to determine whether a fork truck is in the same aisle as another truck within a metal rack system or is instead in an adjacent aisle. This technique allows for the use of magnetic fields while minimizing nuisance alarms and disrupting activities in adjacent aisles. With the continual advancement in high density storage technology, such as very narrow aisle (VNA) racks, the importance of providing greater safety in these modem storage facilities grows continually. For example, order picker fork trucks that transport the operators to heights of 40 feet or more make it very important that there be no contact between trucks and thus, there is room for improved systems for collisions avoidance. More conventional storage rack systems, even with wide aisles, can benefit from improved collision avoidance since a greater amount of interaction between trucks and other trucks and pedestrians may be required.

As another example, there are many identified needs for systems and methods to identify or track or report locations of vehicles, personnel, and products in materials handling operations. Disclosed embodiments have an advantage in doing so because they are coupled with a proven technology for proximity detection. This PDS technology has been organized into an architecture that can effectively be implemented into a very wide range of equipment types that are being utilized in a wide range of industries.

While a typical PDS system can handle general open area environments, in locations that have a special need, such as complex transitions, a PDS system may be augmented by the addition of a FMM, as described herein, that is quickly and easily programmed with standard options and can be easily selected locally so that the safety functions and facility marking is accomplished locally without the need for centralized control. However, by taking advantage of the built-in means of acquiring, storing, and transmitting information that exists in a well-designed, autonomous, PDS, all the information produced by the PDS and the associated FMMs can also be acquired and distributed for use in reporting systems. In summary, and as set forth herein, the safety functions and the information gathering functions are more easily and more reliably performed with an autonomous/de-centralized PDS-FMM architecture than a centralized approach.

In most industrial facilities, there are locations (e.g., POIs) where vehicles, such as fork trucks, should not enter or should enter only with special precaution by the operator. The vehicle should be automatically stopped from entering hazardous zones, such as a doorway that low-profile vehicles may pass through between sections of the facility but through which vehicles with higher profiles cannot pass due to height limitations. In some cases, the vehicles should be automatically slowed so that the operator can better negotiate the movement of the vehicle through the potentially unsafe zone or objects or personnel in that zone. Such zones requiring special attention by an operator, may be created by an activity in the facility or by new objects or materials brought into the facility, or may be a permanent feature within the facility.

Placement of small, portable magnetic field detection devices (e.g., FMMs in accordance with the present disclosure) at POIs or other locations where there are special safety issues, allows the autonomous vehicle and/or the operator thereof to avoid collisions with the facility. The FMMs can also track and easily evaluate the movements of the vehicles at these points or between two or multiple POIs. FMMs according to the present disclosure are configured to automatically transmit a signal to the proximity detection system (PDS) on the vehicle, the signal containing information related to the POI that the FMM is marking.

For instance, in the example of a doorway POI that may be too low for some trucks to pass through the FMM sends a signal to the PDS of a vehicle detected by the FMM to be within a predefined proximity of the FMM or detected by the FMM to be likely to attempt to pass through the doorway. The signal transmitted by the FMM provides the PDS of the vehicle with the height of the doorway. In this example, the PDS of the vehicle has the height of the vehicle (e.g., the mast height of a fork truck vehicle) stored in its memory and is configured to determine if the doorway is higher than the truck. If not, the PDS will warn the driver of the lack of clearance, automatically stop the truck, automatically redirect the truck, automatically slow down the truck, or some combination thereof. Thus, the FMM cooperates with locally detected PDSs of vehicles to increase the vehicles' safety around the FMM's associated POI.

In some examples of FMMs according to the present disclosure, the FMM is configured, in addition or in the alternative, to send its ID to the PDS so that when the vehicle passes a signal relay, data is forwarded to a computing system (e.g., a cloud computing system) for analysis and presentation, e.g., via a user interface operably connected to the computing system.

Based on the computing system's analysis of the data, the computing system can arrive at one or more conclusions, independently of, or in combination with, other data received from that vehicle or another data source. Based on the data and the performed analysis, the user interface can present graphical representations reporting, for instance the number of times the vehicle in question has passed through the doorway associated with the particular FMM within a period of time (e.g., an hour, a day, a week, a month). In another example, based on the data and the performed analysis, the user interface can present graphical representations indicating, for instance, the number of times within a given period of time that all vehicles passed through the doorway associated with the particular FMM (e.g., a representation of total vehicle traffic through the doorway). In another example, based on the data and the performed analysis, the user interface can present one or more alerts (e.g., a visual alert via a display screen of the user interface and/or an audible alert via a speaker if the user interface) indicating the number of times any vehicle attempted to pass through the doorway associated with the particular FMM but were stopped (e.g., by the PDS system of the vehicle following receipt of a signal from the FMM).

Such information, which is based on vehicular data collected by the FMMs, or by the PDS systems of the vehicles of the facility using the FMMs to complete the data, can help, e.g., to determine if additional doorways are needed between facility sections. As another example, such information can serve as a basis to investigate why tall vehicles are attempting to enter sections of the facility that have doorways that are too short.

Because the FMM is location (e.g., POI) specific, the vehicle traffic data sent to, and analyzed by, the back-end computing system is, advantageously, of a limited scope. Thus, for example, the computing system is not tasked with processing all traffic data from all vehicles in the facility, but rather only specific traffic data relating to specific POIs. Thus, advantageously, computer processing efficiency of the traffic data is improved.

In some examples, a FMM according to the present disclosure can be a portable, battery-operated device, having a long life made possible through a hibernation circuit. The hibernation circuit enables the FMM to remain in a hibernated condition until a vehicle, equipped with a pulsed, low frequency, magnetic field, approaches close enough to the FMM for the magnetic field from the vehicle to “wake up” (e.g., activate) the FMM so that it can send signal containing relevant information to the PDS of the approaching vehicle.

The information can be transmitted to the PDS of the approaching vehicle by an ultra-high frequency (UHF) transceiver of the FMM, in response to each magnetic pulse from the PDS. After the transfer of information has been completed, in some examples the FMM returns to hibernation until the next vehicle arrives that triggers the FMM out of hibernation. Alternatively, the FMM can be programmed to continue transmitting until the magnetic field from the vehicle no longer reaches the FMM.

In those examples in which the FMM is portable, the FMM advantageously can be moved from one POI to another POI. For example, if vehicle traffic data associated with a first POI of a facility indicates that no traffic or safety remediation is necessary for vehicular traffic at or around the first POI, the FMM can be easily transferred to a second POI of the facility and mounted to a structure associated with the second POI.

Example applications of FMMs at materials facilities will now be described. FMM's according to the present disclosure can perform location tracking of mobile equipment (e g., vehicles) with PDS installed in order to perform one or more of: monitoring workflows in the facility or other area, identifying areas of vehicular traffic congestion in the facility or other area, monitoring equipment entering of leaving the facility or other area, and/or identifying areas of high risk to personnel from mobile equipment (e.g., vehicles).

FMMs according to the present disclosure can be configured to generate and define speed zones around the POIs with which the FMMs are associated. If a vehicle enters a speed zone, as detected by the FMM, the FMM can send a signal to the PDS of the vehicle that causes, e.g., via a controller, automatic slowing or stopping of the vehicle within the speed zone (e.g., at or near the POI). Speed zones can be set up, for, example, around curves, doorways, limited visibility areas, or other potentially hazardous areas or features of a facility. Distinct alerts, generated by the vehicle PDS system in response to the signal(s) received from the FMM can also be provided in these cases to the operator of the equipment.

A FMM signal transmitted by the FMM in response to detection of a vehicle can also cause activation of one or more alerting devices for alerting those within areas (within the facility or outside of the facility) of the presence of the vehicle. The alerting devices can be affixed to a vehicle or to a structure within the facility. Examples of such alerting devices can include warning lights and/or horns. Additional safety devices can be controlled and activated in response to signals transmitted by the FMM, such as gates that can be opened and closed in response to the FMM signal.

FMMs according to the present disclosure can serve as equipment guarding devices that minimize or prevent collisions between the detected vehicle with PDS and other equipment, such as cranes, machinery, or other industrial equipment, by providing an alert to the operator of the other equipment (in response to the signal transmitted by the FMM in response to the FMM's detection of the vehicle's PDS) with the ability to disable the other equipment.

FMMs according to the present disclosure can serve as access limitation devices, permitting only vehicles (with detectable PDS installed) that meet predefined specific criteria (e.g., vehicles under a certain size or weight, or vehicles capable of travelling only below a certain predefined speed) to enter an area associated with the POI. For example, an FMM can be configured to restrict access to a POI based one or more of the detected vehicle's mast height, equipment ID, operator ID, equipment type, speed of entry, and so forth. If the POI is accessed by the vehicle, an alarm (e.g., on the vehicle or at or near the POI) is automatically triggered by a response signal from the FMM associated with the accessed POI. In other examples, the vehicle may be automatically stopped in response to the response signal from the FMM. In addition, or alternatively, the unauthorized POI access event can be reported by the FMM to a backend traffic monitoring computing system that can provide a report of the event to a facility manager via a user interface.

FMMs according to the present disclosure can provide advanced intersection control by, e.g., interfacing multiple FMMs together, allowing for first in first out logic to be executed by the FMMs in controlling, e.g., traffic lights or priority to specific road configurations and/or vehicle traffic patterns.

FMMs according to the present disclosure can serve as aisle markers, e.g., markers of very narrow aisles (VNAs) The transmitted signals by the FMMs can cause vehicles to automatically stop at the ends of aisles associated with the FMMs. The FMMs can also track and analyze vehicle entry to, and exit from, POI aisles in facilities, such as distribution centers. As end of aisle markers, FMMs can be configured to allow for special right of way intersection logic with automated enforcement by automated slowing and/or stopping of vehicles at or near the ends of POI aisles.

A given FMM can be configured to provide one or more of the various FMM functions described herein, including one or more (or all) of the functions just described. Thus, an FMM can be a multipurpose or multifunction FMM. In some examples, an FMM can be configured to have selectable modes in order to perform different functions. The FMM can include remote controllable switches that can be used to switch the FMM from one operating mode (e g, traffic data collection assistance) to another mode (e.g., collision avoidance). In addition, a given facility can include multiple versions of FMMs that provide different functionality.

In order to achieve the FMM functionality described herein and encompassed by this disclosure, as previously described the FMM is configured to detect the arrival of a vehicle and to transmit information to the vehicle.

In the case of a portable FMM (e.g., a FMM small enough to fit in one's hand), the FMM also includes a battery and can include power-saving features (such as a hibernation circuit) to extend or maximize the operating life of the FMM and minimize the labor required to replace or recharge batteries. Facility managers can have a tendency to avoid battery changes. In some examples, the FMM (e.g., the portable, battery-powered FMM) can be configured to generate an alert when the battery's voltage drops below a minimum predefined threshold, the alert indicating that the battery should be replaced or recharged soon, e.g., within ten days.

Many types of facilities can benefit from the use of FMMs according to the present disclosure. Non-limiting examples of such facilities include open warehouses, warehouses with dense VNA metal storage racks, manufacturing facilities with storage areas and shipping docks, roadways along which vehicles travel, office areas and workstations that pedestrians walk into and out of, and so forth.

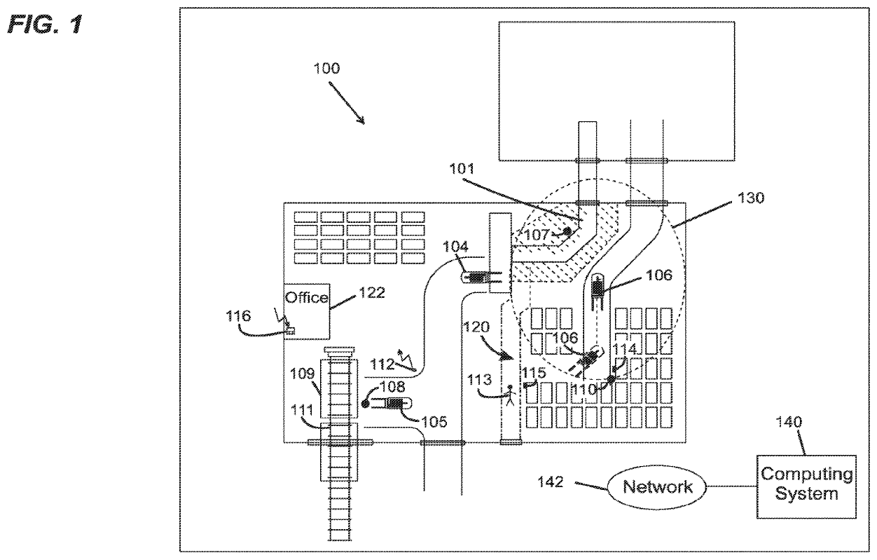

FIG. 1 is a schematic representation of an example facility 100 with vehicles 104, 105 106, points of interest, and facility marking modules of an example point of interest vehicular control system in accordance with the present disclosure. FIG. 1 represents, in a simplified fashion, typical activities and situations in an open warehouse where building products such as plywood or sheetrock or other products would be held and then be loaded onto shipping trucks for shipping.

Within facility layouts, due to the need to maximize usage of the floor space and manufacturing process layouts, blind spots exist that can be potentially hazardous when multiple vehicles or vehicles and personnel are approaching from opposite directions.

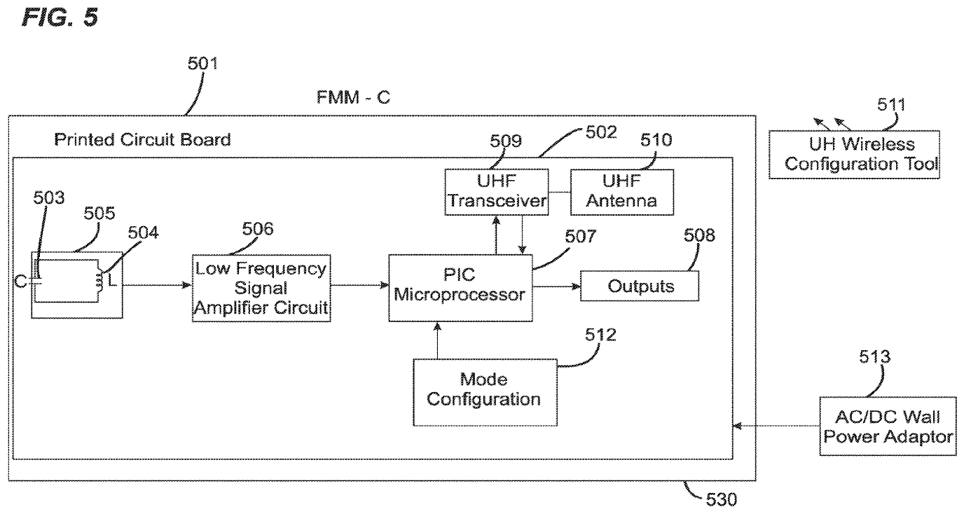

In the scenario depicted in the facility 100 of FIG. 1, a fork truck vehicle 106 equipped with a PDS is approaching a FMM 110, which is located at a blind corner intersection 120. The FMM 110 can be configured as a comer type FMM (or FMM-C). That is, the FMM 110 can be configured to serve a comer type POI, e.g., at a corner formed by one or more roadways or vehicle pathways. Components of an example FMM-C are shown in FIG. 5.

The FMM 110 receives low frequency magnetic field transmission on a tank circuit 505 (FIG. 5) of the FMM 110. The low frequency magnetic field is transmitted by the PDS of the fork truck 106. The received magnetic field signal is processed by a processor 507 (FIG. 5) of the FMM 110, and a timed data packet is returned via the UHF transceiver 509 (FIG. 5) of the FMM 110 back to the PDS on the fork truck 106.

In response to the received magnetic field signal, the FMM 110 is also configured to turn on outputs 508 (FIG. 5) of the FMM 110. The outputs 508 drive an alerting system. In the example shown in FIG. 1, the alerting system includes strobe lights 114, 115 driven by the outputs 508 of the FMM 110. In other examples, the alerting systems can include another signaling device driven by the outputs 508, such as an audible alarm generated by a speaker.

Having received the data packet from the FMM 110, the PDS of the fork truck 106 has information that the fork truck 106 passed the FMM 110. At the same time, a pedestrian 113 who was entering the blind corner intersection 120 by FMM 110 can see the strobe light 115 and not enter the intersection 120 until the fork truck 106 has cleared the intersection 120. This allows both the pedestrian 113 and the fork truck 106 to navigate the blind corner safely.

As the fork truck 106 passes the relay 112 in the facility 100, the intersection data obtained by the FMM 110 is sent (e.g., via data network 142) to a backend traffic monitoring computing system 140, e.g., a cloud computing system, associated with the facility 100. Using a user interface provided on the computer terminal 116 in an office 122, the user is notified of the time at which the intersection 120 was passed by fork truck 106. The computing system 140 provides, via the network 142, information that can be viewed at the computer terminal 116.

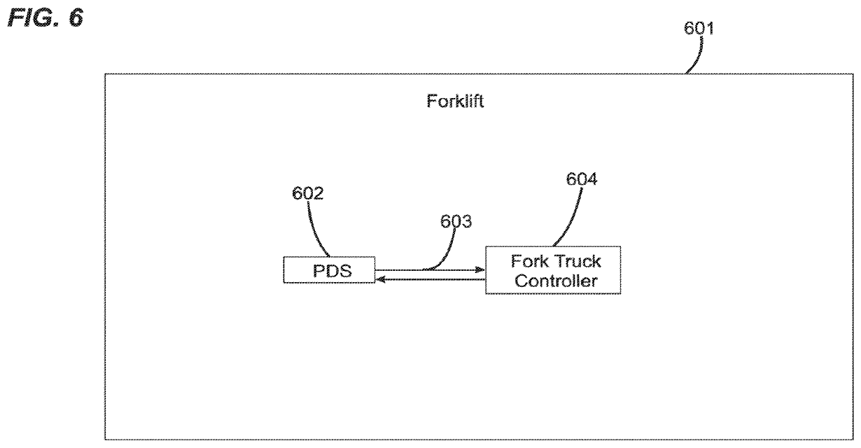

Many tight intersections of materials handling facilities are a potential for truck roll over or tipping of loads. Too-high speed is usually a major factor in these situations. FMMs according to the present disclosure can alleviate this problem as well. For example, the FMM 110 can be configured to provide a speed restriction via the timed packet sent to the fork truck 106. As the fork truck 106 is entering the intersection 120, the speed of the fork truck must be under a predefined threshold (e.g., under 2 miles per hour). If the fork truck 106 is detected to be travelling faster than the speed restriction, the PDS System 602 (FIG. 6) of the fork truck 106 transmits, via a truck communication system 603 that can include, for example a Controller Area Network (CAN) bus, a command to slow down. The command is received by the truck controller 604 (FIG. 6). In this manner, the FMM's response to receiving the low frequency magnetic field generated by the PDS of the fork truck 106 causes a chain of communications and commands that automatically slows down the fork truck 106 to at below the predefined speed threshold. Stopping of the vehicle can be performed in a similar manner by generating a stop command.

Still referring to the system represented in FIG. 1, travel time can also be recorded as the fork truck 106 passes another FMM 107 over a conveyor 101 and enters a predefined zone around the FMM 110. The zone can be a predefined radius around the FMM 110 in which the FMM 110 is responsive to low frequency magnetic fields generated by the PDS of the fork truck 106, and outside of which the FMM 110 is not responsive (e.g., remains in hibernation) to low frequency magnetic fields generated by the PDS of the fork truck 106.

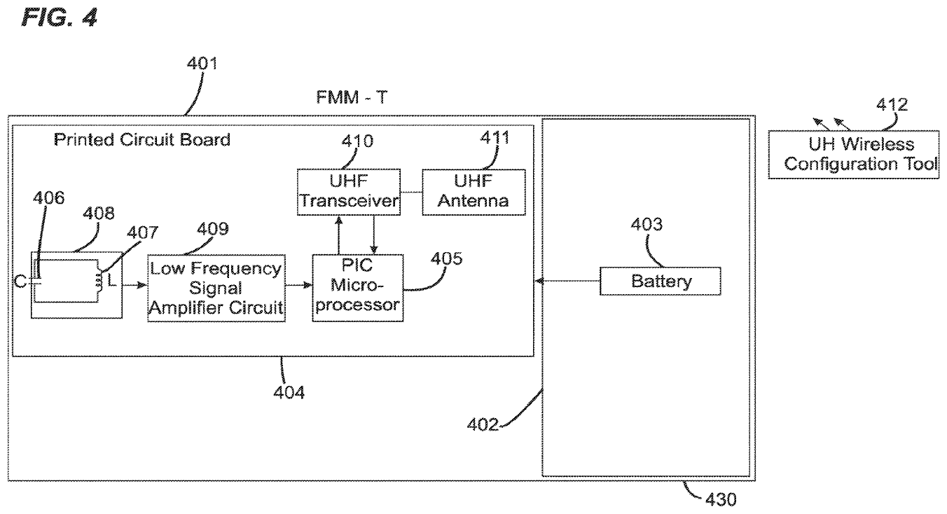

The FMM 107 can be configured as a tracking type FMM (or FMM-T). That is, the FMM 107 can be configured to serve, at least primarily and/or at least temporarily, as a vehicle tracking device for an area associated with a POI in which the FMM 107 is mounted. Components of an example FMM-T are shown in FIG. 4.

The FMM 107 is configured to record the time of entry of each vehicle (e.g., of the fork trick 106) into the hashed zone 130 around the conveyor 101. The FMM 107 is also configured to provide a slow or stop command to any fork truck in the zone 130 to prevent a collision with the conveyor 101, in a manner as described above in connection with the FMM 110.

The FMM 107 is also configured to provide tracking information to another fork truck 104 in the facility that is unloading the conveyor 101. This tracking information is stored in the PDS of the fork truck 104 and transmitted via the relay 112 (e.g., as the fork trick 104 travels by the relay 112) to the backend traffic monitoring computing system 140 that processes traffic information.

The FMM 108 of the system represented in FIG. 1 is a FMM-T for monitoring loading and unloading of the railcar 109 on the tracks 111. As the load of the fork truck 105 enters the railcar 109, the time is recorded and stored by the PDS of the fork truck 105 in response to the receiving the tracking data from the FMM 108. As the fork truck 105 travels by the relay 112, the information is then passed via the relay 112 to the backend computing system 140 for processing of the tracking data and presentation thereof via the computer terminal 116.

In some examples of the system represented in FIG. 1, the relay 112 is not needed. That is, information can be transmitted directly to the backend computing system 140 via the network 142 from the PDS system of the fork truck or other vehicle.

The backend computing system 140 can include one or more processors and a non-transitory computer-readable medium storing instructions which, when executed by the one or more processors, causes the processor to perform the functionality of the computing system 140 described herein.

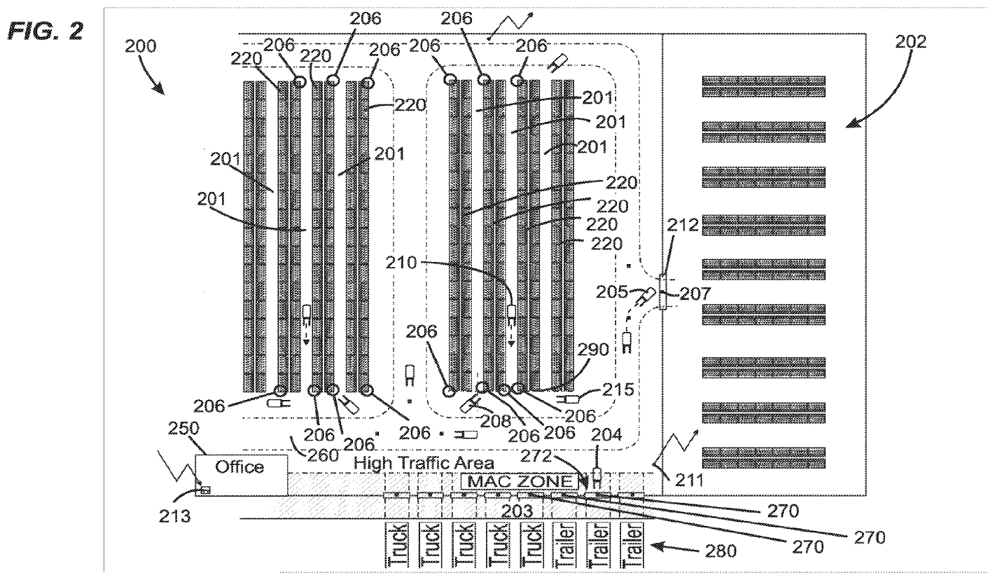

FIG. 2 is a schematic representation of an example distribution center 200 with very narrow aisles (e.g., the aisles 201) and cold storage 202, and with vehicles, points of interest, and facility marking modules of a further example of a point of interest vehicular control system in accordance with the present disclosure. FIG. 2 represents, in a simplified fashion, typical activities and situations in a warehouse where a section of the storage includes very narrow aisles 201 and another section of storage is cold storage 202.

As discussed above, low frequency magnetic fields are stable and precise, in that their shape is not significantly altered by most materials and objects. Discrete metal objects, non-metallic objects, and most other items allows passage therethrough of the magnetic fields. While a large, solid metal wall may attenuate the fields that pass through the metal and extend the field along the wall, this of no concern in situations such as that depicted in FIG. 2 because if a vehicle equipped with a PDS is separated from pedestrians or other trucks by metal walls, there is no danger of collisions.

The low frequency magnetic fields of vehicle PDS systems can also pass through metal storage racks, such as storage racks 220 of distribution center 200, so that vehicles approaching the end of aisles within rack systems and vehicles on roadways outside the racks can detect each other using their PDS systems and thereby avoid collisions. By analyzing the vector components of the magnetic fields, trucks working within metal storage rack systems (such as between and around the racks 220) can ignore trucks in adjacent aisles since the trucks cannot collide. Modern PDS systems have the capability of exchanging data packets at UHF or higher frequencies in order to handle these applications. The Frederick patents detail the use of these magnetic field vectors in VNA storage racks for alerts when two or more vehicles are in close proximity in the same aisle.

The distribution center 200 can include, or be associated, with a backend computing system, such as the computing system 140 (FIG. 1) that communicates, via a network, with electronic components positioned through the distribution center, such as a computer terminal 213 in an office 250 of the distribution center 200, one or more relays 211, FMMs 206, and/or PDS systems of vehicles such fork trucks.

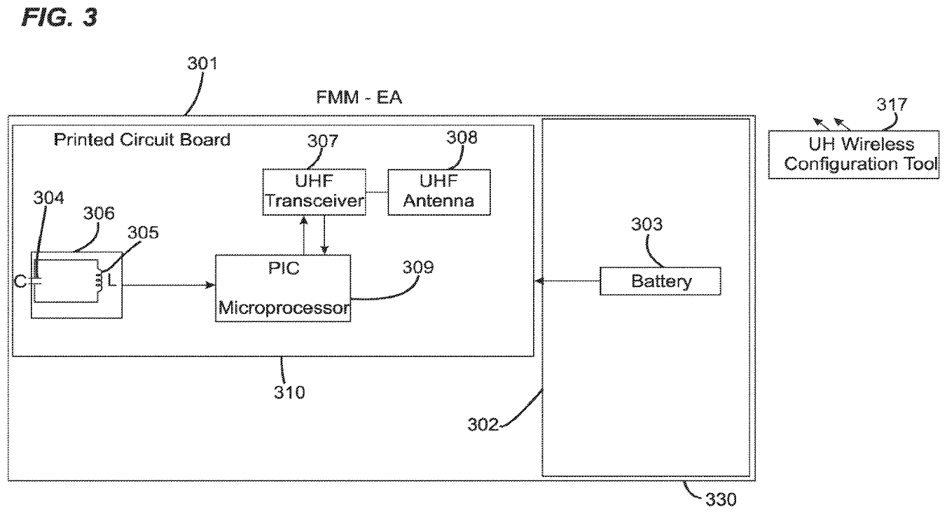

FMMs 206 in the distribution center 200 can be configured as end-of-aisle type FMMs (or FMM-EAs). That is, the FMMs 206 can be configured to serve end-of-aisle type POIs. The FMMs 206 can be mounted to, e.g., a rack, the floor, the ceiling, or another structure at or near a given end of aisle. Components of an example FMM-EA are shown in FIG. 3.

The FMMs 206 are placed at the end of aisles 201 and are configured to perform multiple functions, such as causing, by transmitting a response signal to the PDS of a vehicle that has been detected by the FMM, automated slow down or stoppage of the vehicle before the vehicle enters into the roadway 260 or exits from the aisle 201 corresponding to the FMM. The FMM 206 can also track entry and exit times fur each unique aisle 201, and transmit that data to the backend computing system for future traffic management and control within the distribution center 200. For example, the backend computing system can identify points of traffic congestion at certain times of day and/or days of the week, and traffic pattern rules can be established to mitigate such congestion.

In some examples, the FMM 206 can be configured also to report last known locations for each vehicle using a heat map.

As distribution facilities across the globe are expanding, the operations are becoming complex and efficiency is being maximized, increasing congestion and additional challenges such as different service heights of racking in various segments of the warehouse or other distribution center. Fork truck operators (and operators of other vehicles) must be aware of the mast height of their vehicle and not enter through a door (or doorway) that is too low. Additional complications exist when the fork truck operators must operate multiple forklifts with different dimensions in the same day. Accidents occur when a fork truck enters through a door that is too low (or too narrow), damaging property and putting lives at risk.

Still referring to the distribution center 200 of FIG. 2 and the scenario depicted therein, a fork truck 205, equipped with a PDS, approaches the overhead door 212 marked with a FMM 207 in order to enter the cold storage area 202. The FMM can be fixed to the door 212 or to another structure near the door 212. Thus, the door 212 is a POI with which the FMM 207 is associated. The FMM 207 is configured as a FMM-T (FIG. 4).

The fork truck 205 receives its mast height stored in the computer controller 604 (FIG. 6) via the communication bus 603, which may be the truck CAN bus or other bidirectional communication. As the fork truck 205 approaches and is in the predefined triggering range of the battery 403 (FIG. 4) of the FMM 207, the FMM 207 comes out of hibernation and powers up, and receives, via components 408 and 409 (FIG. 4) a low frequency magnetic field PING generated by the PDS system on the fork truck 205. The processor 405 (FIG. 4) of the FMM 207 is configured to then automatically power on the radio of the FMM 207, the radio including a UHF transceiver 410 and a UHF antenna 411 (FIG. 4). The radio of the FMM 207 transmits a data packet at a precise predefined time following receipt of the PING. The data packet is received by the PDS of the fork truck 205. This data packet provides, to the PDS of the fork truck, information including, at least, the ID of the FMM 207 and the height of the doorway 212.

The FMM 207 can be pre-configured to know the height of the doorway 212. For example, a FMM configuration tool, such as the wireless configuration tool 412 (FIG. 4), can be used to program the FMM 207 upon its installation at the POI 212 to know information about the POI it is associated with, such as, in this case, the height of the door 212.

With POI information transmitted to the autonomous PDS system on the fork truck 205, the PDS or other automated system of the fork truck 205 determines whether the fork truck 205 will clear the doorway 212. Since the PDS of the fork truck 205 has already received its mast height from the truck controller 604 (FIG. 6), and the PDS of the fork truck 205 also knows the height of the marked doorway 212 as informed by the FMM 207, the PDS (or other system) can determine it will be able to clear or will not be able to clear the doorway 212.

If the PDS of the fork truck 205 determines that it is possible to clear the doorway 212, no speed restrictions or alerts will be provided, and the truck 205 will pass through.

If the PDS of the fork truck 205 determines that it is not possible to clear the doorway 212 (e.g., the mast of the truck 205 is too high for the doorway 212), then the PDS automatically generates a signal to stop before entry through the doorway 212, which signal is provided to the truck controller 604 (FIG. 6) that then slows and/or stops the truck 205 automatically, thereby preventing collision that could have resulted in bodily injury and/or facility damage.

The interaction between the FMM 207 and the PDS of the vehicle 205 is also stored in the memory of the PDS of the fork truck 205 for communication to the computer terminal 213 via the data relay 211 and the backend computing system.

Based on the interaction between the PDS of the fork truck 205 and the FMM 207, the fork truck 205 also knows its location at a specific time. Based on this location information, the fork truck 205 can be controlled (by the operator or automatically) to enter the freezer and perform its loading or unloading function at the racks. As the fork truck 205 leaves that area, it will again exchange data packets with the FMM 207, resulting in a recordation of the exit time from the freezer. As the fork truck 205 passes the relay 211 this traffic data will be transmitted to the backend computing system.

Using a user interface of the computer terminal 213, a user will be able to determine, based on the traffic data transmitted to the backend computing system from the PDS systems of the vehicles in the distribution center 200, how long it is taking the vehicles to service the freezer racks. Likewise, the user can determine slowdowns or other traffic congestion at the doors due to mast height restrictions, and travel times between POIs, such as freezer door and the relay, among others. Based on such data, remedial measures can be taken (e.g., truck operator restrictions, vehicle speed restrictions around certain POIs, modifications to traffic paths along roadways) to alleviate traffic congestion and/or minimize collisions or other unsafe conditions.

The facility 200 includes loading docks 203 where fork trucks load materials onto shipping trucks or trailer, 280. As depicted in FIG. 2, a fork truck 204 enters the portal area, with each portal marked with a FMM 270. Each FMM 270 is mounted to, or near, a specific portal 272. Thus, each portal 272 is another POI of the distribution center 200.

As the fork truck 204 enters the portal area and a specific portal 272, the FMM 270 sends a data packet to the PDS of the fork truck 204 providing, to the PDS of the fork truck 204, the portal number of the portal 272 and a command to reduce the magnetic field size generated by the PDS of the fork truck 204. By reducing the magnetic field size, unwanted alerts in neighboring docking portals 272 associated with their own FMMs can be minimized, since the magnetic fields will be too weak to trigger the FMMs 270 of neighboring portals.

Following unloading onto a truck or trailer, the fork truck 204 reenters the roadway 260 and drives within the detection zone of the relay 211. At this time, the portal entry and exit timing of the vehicle 204 is recorded and provided to the backend computing system as additional traffic data from which traffic efficiency and safety adjustments for the overall running of the distribution center 200 can be made.

As previously described, each aisle 201 in the facility 200 is marked with a FMM-EA 206 fixed in position at or near each end of a corresponding aisle. The intersections between the racking system that defines the very narrow aisles 201 and the roadway 260 has inherent risks. For example, the fork truck 210 approaches the end of an aisle 201 as the fork truck 215 is driving across the rack face 290 while line of sight is blocked by the rack structure. The FMM 206 associated with the aisle in which the fork truck 210 is positioned receives the magnetic field generated by the PDS of the fork truck 210 and communicates and responds to the PDS of the fork truck 210 with a signal that causes the fork truck 210 to automatically stop at the end of the aisle before exiting the rack system, thereby avoiding a collision between the fork trucks 210 and 215.

Meanwhile, the fork truck 208 enters the rack system and passes another FMM-EA 206, which causes the position of the fork truck 208 in the rack system to be stored and processed by the backend computing systems as traffic data. In addition, fork trucks 208 and 210 can interact with each other using magnetic field vectors as disclosed in the Frederick patents.

FIG. 3 is a schematic representation of an embodiment of a facility marker module according to the present disclosure. In particular, FIG. 3 includes a block diagram of an example FMM-EA 301. The FMM 301 contains a circuit board 310 that supports and includes a capacitor 304, an inductor 305, and a tuned circuit 306 all configured for reception of low-frequency field signals. When a low frequency magnetic field signal is received (e.g., from a vehicle PDS), it is interpreted by the processor 309. If the signal is valid, the FMM 301 responds (e.g., to the PDS of a vehicle) with a timed UHF transmission via the UHF transceiver 307 and the antenna 308. The frequency of the UHF transceiver may vary. The FMM is powered with a battery 303. In some examples, the battery 303 is positioned within a dedicated housing 330 of the FMM 301. The housing 330 can house all components of the FMM 301 and is configured to be mounted to a structure at or near a POI of a facility. The housing 330 can be a plastic enclosure with a removable battery lid 302 for easy replacement of the battery 303, e.g. every two years. Exact construction of the device enclosure may vary. To configure the specific functionality of the FMM 301 as described herein, a wireless UHF configuration tool 317 can be used.

FIG. 4 is a schematic representation of a further embodiment of a facility marker module 401 according to the present disclosure. In particular, FIG. 4 is a block diagram an example FMM-T 401. The FMM 401 includes a circuit board 404 supporting and including a capacitor 406, an inductor 407, and a tuned circuit 408 for reception of low frequency magnetic fields. The signal from the LC circuit 408 is then amplified by an amplifier circuit 409 of the circuit board 404. When a low frequency magnetic field signal having an amplitude above a predefined threshold is received by the processor 405, it then responds to the PDS of the vehicle that triggered the FMM 401 with a timed UHF transmission via the UHF transceiver 410 and the antenna 411. The frequency of the UHF transceiver may vary. The FMM is powered with a battery 403. In some examples, the battery 403 is positioned within a dedicated housing 430 of the FMM 401. The housing 430 can house all components of the FMM 401 and is configured to be mounted to a structure at or near a POI of a facility. The housing 430 can be a plastic enclosure with a removable battery lid 402 for easy replacement when needed. To configure the specific functionality of the FMM 401 as described herein, the wireless UHF configuration tool 412 can be used.

FIG. 5 is a schematic representation of a further embodiment of a facility marker module 501 according to the present disclosure. In particular, FIG. 5 shows a block diagram of a FMM-C 501. The FMM-C 501 includes a circuit board 502 that supports and includes a capacitor 503, an inductor 504, and a tuned circuit 505 (or multiple tuned circuits) for reception of low-frequency fields from PDS systems of vehicles. The signal from the LC circuit 505 is then amplified by an amplifier circuit 506. When a signal having an amplitude above a predefined threshold is received by the processor 507, it then responds with a timed UHF transmission via the UHF transceiver 509 and the antenna 510. The frequency of the UHF transceiver may vary. The FMM 501 is powered via a standard wall transformer 513. The FMM 501 can be boused in a dedicated plastic enclosure 530. Exact construction of the device enclosure may vary. To configure the specific functionality of the FMM 501 as described herein, a wireless UHF configuration tool 511 can be used. In addition, the FMM 501 includes one or more mode configuration switches 512, enabling the operational mode of the FMM 501 to be changed, as described herein. For example, using the switch or switches 512 (which can be controlled by the configuration tool 511), the FMM 501 can be switched from a mode in which it records traffic data to a mode in which it actively manages vehicular traffic in real time for collision avoidance.

FIG. 6 is a schematic representation of an example vehicle control interface 601, in accordance with the present disclosure. In particular, FIG. 6 depicts an interface of the PDS system 602 of a vehicle (such as a fork truck) to a controller 604 of the vehicle via a bi-directional communication protocol 603, such as CAN BUS. This interface enables, for example, slow and stop commands to be provided to the fork truck controller, which are then executed by the controller 604 to slow or stop the fork truck, as described herein. In addition, vehicle-specific data, such as vehicle ID, operator ID, mast height, vehicle width, vehicle speed, vehicle weight, and so forth, can be accessed from the controller 604.

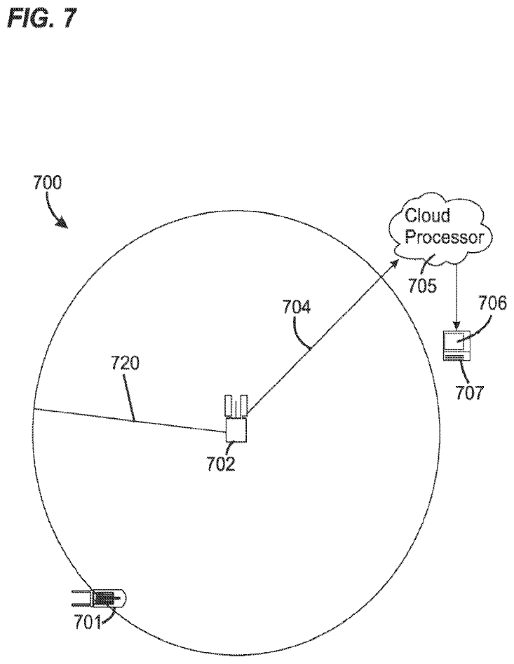

FIG. 7 is a schematic representation of an example event monitoring system of the present disclosure, using one or more facility marker modules in accordance with the present disclosure. When a vehicle (e.g., a fork truck) 701 equipped with a PDS system is within a predefined radius 720 (e.g., 100 feet) of a data relay 702 positioned in the facility, the information stored on the vehicle including proximity information, tracking information and any other traffic data for that vehicle is offloaded. This radius 720 can also be used to set a range in within which traffic data is collected and outside of which traffic data is not collected. The data relay can then transfer the collected data via a cellular or WiFi link 704 (which can correspond to the network 142 of FIG. 1) to the backend computing system (such as the backend computing system 140 of FIG. 1). The backend computing system can include a cloud processor 705 and storage for storing and processing the data. A user can access the data via a dashboard at any computer terminal 707 via a user interface 706 that is connected by the network to the cloud processor and storage.

As discussed above, along with improved safety there has arisen a desire by and an opportunity for safety directors and other managers to obtain accurate information about safety events and practices related to the equipment in their fleets that are using proximity detection systems. Through the use of relays, as described herein, the PDS can report data about events, such as passing near an FMM or being near another vehicle or worker. The data can result in increased knowledge and situational awareness about the use of resources throughout the worksite (or other facility).

Significant benefits can be gained from acquiring the POI-specific information that is being produced by these precision PDS and FMM devices and by associated facility items, and then sending that information to other backend computing systems, as described herein. Logic devices at remote locations may take automatic actions to send reports and/or alerts or take other actions to improve safety or to improve the efficiency of the operation. As described, many other kinds of information can be acquired from vehicles for transmission along with the proximity event and traffic flow information, adding to the overall utility and value of the vehicle control system.

As disclosed herein, such transmission may be made through relays. Relays, such as the relays disclosed herein, can be outfitted with suitable radio frequency (RF) receivers or transceivers to receive communications form PDSs and also to send the information about vehicle traffic event to a backend computing system. The relays will include another appropriate communication infrastructure for integrating with the onsite infrastructure, whether it be Wi-Fi, ethernet, RF, or the like. This information includes such things as to whether the event was due to entering the Warning level or the Danger level, the serial number (e.g., the ID) of the trucks involved, status information, and other information that are part of the traffic event detected a FMM. The event information, which is the same as traffic data as described herein, may be distributed to authorized users through, for example, on or off-site information technology infrastructure. Some example configurations may include intranets, extranets, wide-area networks, local area networks, or similar.

In one example embodiment, the event data can also be used to provide real-time, or near-real-time, reports and/or historical reports to safety directors, and/or corporate managers that may be located around the world. Further example configurations and example of event data will be given below.

Event data can be transferred as raw data or as reports. The event data, in one example can be processed locally PDS or a local processing facility. In another example, it can be transferred to a remote collection and/or reporting facility, such as an internet service provider or other internet based computing provider (cloud computing provider). Information that is captured by PDS can be output via a communication system, such as a transmitter or transceiver to relays in the facility or area of operation. The communication system, in one example, can be a radio frequency transmitter or transceiver such as those configured to operate under various WiFi protocols, or at UHF frequencies.

Autonomous, de-centralized, self-controlled proximity detection ensures a high level of protection from collisions, without depending upon information from a centralized system that must continuously be kept updated and functional The addition of the FMMs described herein alters the operation of PDS systems to make them practical to use within rack systems and other POIs, provides accurate tracking data between important points within a facility. Cooperation between the FMMs and the PDSs as described herein can accommodate special requirements to further improve safety and improve the functionality of these devices.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acia, or media are disclosed only as illustrative embodiments. The scope of the technology is defined by the following claims and any equivalents therein.

1. A point of interest (POI) vehicular control system, comprising:
a fixed-position facility marker module (FMM) associated with the POI and mounted to a fixed structure at or near the POI, the FMM including:
a processor;
a tuned circuit configured to receive low magnetic frequency fields, the tuned circuit including a capacitor and an inductor;
a UHF transceiver; and
an antenna;
wherein the FMM is configured to transmit a signal using the processor, the UHF transceiver and the antenna only in response to receiving, by the tuned circuit, a pulse of a low frequency magnetic field.

2. The POI vehicular control system of claim 1, wherein the FMM is fixed to a doorway.

3. The POI vehicular control system of claim 1, wherein the signal includes information about a clearance at the fixed structure.

4. The POI vehicular control system of claim 1, wherein the signal includes a command to stop, to slow down, or to redirect a moving vehicle, or a command to reduce a low frequency magnetic field strength.

5. The POI vehicular control system of claim 4, wherein receipt of the signal by a controller of the moving vehicle automatically causes the moving vehicle to stop, to slow down, or to change direction.

6. The POI vehicular control system of claim 1, wherein receipt of the signal by a controller of the moving vehicle automatically causes an alarm of a vehicle to activate.

7. The POI vehicular control system of claim 1, wherein the signal is configured based on at least one of:
a speed of a vehicle detected by the FMM;
a height of the vehicle detected by the FMM;
an identification of the vehicle detected by the FMM;
a type of the vehicle detected by the FMM;
an operator of the vehicle detected by the FMM; and
a type of the POI.

8. The POI vehicular control system of claim 1, wherein the signal transmitted by the FMM is received by a proximity detection system (PDS) of a vehicle.

9. The POI vehicular control system of claim 1, wherein the pulse is generated by a proximity detection system (PDS) of a vehicle.

10. The POI vehicular control system of claim 1, wherein vehicular traffic data provided by the FMM about a vehicle detected by the FMM is transmitted to a backend computing system.

11. The POI vehicular control system of claim 10, wherein the backend computing system is configured to generate a vehicle traffic report for the POI based on the vehicular traffic data.

12. The POI vehicular control system of claim 10, wherein the vehicular traffic data includes one or more of:
a speed of the vehicle;
a serial number of the vehicle;
a height of the vehicle;
a time that the vehicle was detected by the FMM;
a direction of motion of the vehicle; and
a type of the POI.

13. The POI vehicular control system of claim 1, wherein the POI is one of:
a corner or intersection between vehicle roadways;
an end of an aisle of storage racks;
a portal of a loading dock; and
a doorway.

14-16. (canceled)

17. The POI vehicular control system of claim 1, wherein the FMM includes a dedicated housing configured to be mounted to the fixed structure, the housing supporting the processor, the tuned circuit, the UHF transceiver and the antenna.

18. The POI vehicular control system of claim 17, wherein the housing houses a battery that powers the FMM.

19. The POI vehicular control system of claim 1, wherein the FMM includes an amplifier operatively coupled to the tuned circuit.

20. The POI vehicular control system of claim 1, wherein the FMM includes one or more switches for switching an operational mode of the FMM.

21. The POI vehicular control system of claim 1, further comprising a UHF wireless configuration tool for configuring an operating aspect of the FMM.

22. A facility marker module (FMM), comprising:
a housing, supporting:
a processor;
a tuned circuit configured to receive low magnetic frequency fields, the tuned circuit including a capacitor and an inductor;
a UHF transceiver; and
an antenna;
wherein the FMM is configured to transmit signals using the processor, the UHF transceiver and the antenna only in response to receiving, by the tuned circuit, a pulse of a low frequency magnetic field; and
wherein the housing is configured to be mounted to a structure associated with a point of interest of a facility.

23. The FMM of claim 22, wherein the housing further supports a battery for powering the FMM.

24. The FMM of claim 23, wherein the FMM includes a hibernation circuit operatively coupled to the battery.

25-29. (canceled)

30. The FMM of claim 22,
wherein the housing is mounted to the structure; and
wherein the FMM is configured to transmit a signal that includes information about the structure.

31. A facility marker module (FMM), comprising:
a housing, supporting: a processor;
a tuned circuit configured to receive low magnetic frequency fields, the tuned circuit including a capacitor and an inductor;
a UHF transceiver; and
an antenna;
wherein the housing is configured to be mounted to a structure associated with a point of interest of a facility; and
wherein the FMM is configured to transmit a signal using the processor, the UHF transceiver and the antenna in response to receiving, by the tuned circuit, a pulse of a low frequency magnetic field, the signal including information about the structure.

32. The FMM of claim 31, wherein the information includes a clearance.

33. The FMM of claim 31, wherein the information includes a type of a point of interest associated with the structure.
